(19) United States
(12) Patent Application Publication
(10) Pub. No.: US 2002/0093117 A1
(43) Pub. Date: Jul. 18, 2002

(54) Method of manufacturing articles utilizing a composite material having a high density of small particles in a matrix material

(76) Inventors: Larry J. Winget, Leonard, MI (US); Darius J. Preisler, Macomb, MI (US); Lloyd R. Hilligoss, South Lyon, MI (US)

Correspondence Address: Welsh & Katz, Ltd., Jeffrey W. Salmon, 22nd Floor, 120 South Riverside Plaza, Chicago, IL, 60606, US

(21) Appl. No.: 09/797,279

(22) Filed: Mar. 1, 2001

Related U.S. Application Data
(63) Continuation-in-part of application No. 09/761,094, filed on Jan. 16, 2001.

(51) Int. Cl. B29C 47/06; B32B 31/30

(52) U.S. Cl. 264/171.13; 264/171.14

(57) ABSTRACT

A method of manufacturing articles utilizing a composite material having a high density of small particles such as microspheres in a matrix material is disclosed. One aspect of the present invention is that at least first and second layers of flanking material that are disposed in a generally non-parallel relationship with respect to each other are pulled through a die while a composite material is injected into a space defined between the at least first and second layers of flanking material. The composite material and the at least first and second layers of flanking material are heated as they pass through the die to cure the composite material and bond the at least two flanking material layers to the composite material, thereby forming a cured article.

### CROSS-REFERENCE TO RELATED APPLICATIONS

This application is a continuation-in-part of U.S. application that was filed Nov. 9, 2000, that is entitled “Method of Manufacturing Articles Utilizing A Composite Material Having A High Density Of Small Particles In A Matrix Material,” and that names Darius J. Preisler as sole inventor of the subject disclosed and claimed therein.

### FIELD OF THE INVENTION

The present invention generally relates to composite materials having a high density of small particles such as microspheres in a matrix material and, more particularly, to a method for manufacturing articles utilizing a such a composite material.

### BACKGROUND OF THE INVENTION

U.S. patent application Ser. No. 09/634,522, filed Aug. 8, 2000 (the “CM application”) discloses certain new composite materials. Such materials include a matrix material that has a high density of small particles such as, for example, microspheres disposed therein. The CM application teaches that there are a large amount of the small particles relative to the amount of the matrix material such that there is a high-density packing of small particles into the matrix material. An aspect of the invention disclosed in the CM application is that the small particles are positioned very close together, and many of the small particles may even be in contact with adjacent small particles. The CM application states that the matrix material fills the interstitial space between the small particles, and that the composite material can include a greater amount of small particles than matrix material by volume, weight and ratios or percentages of weight and volume. The content of the CM application is incorporated by reference into this application as if fully set forth herein.

The CM application states that a mixing and molding process was used to make sample composite material plaques that have a flat, generally square or rectangular shape. The CM application also states that microspheres were mixed with automotive grade polyester, phenolic or vinyl ester resins to saturate the resin with microspheres to form a core of clay-like uncured composite material mixture.

The CM application states that the clay-like composite material mixture core was flattened in a sheet molding compound (SMC) hydraulic plaque press into a flat, plate-like plaque shape, and then the flattened core was removed from the press. The CM application states that dry cross-woven carbon fiber was applied to both side faces of the composite material core. The CM application states that, optionally, filter paper (coffee-type filter paper) was flanked on both sides of the fiber/core/fiber sandwich-type structure and sealed on all four edges to form a sealed filter bag encasing the fiber/core/fiber structure. The CM application states that the encased structure was inserted into the hydraulic press, the press was heated, and the plaque press compressed the encased structure for approximately 3 minutes.

The heat applied during compression cured the thermoset resin, as stated in the CM application. Upon opening the press, the sample composite plaque was observed to have fully wetted-out the flanking woven fiber, and evidence of the microspheres was clearly visible through the transparent filter paper, as stated in the CM application. The CM application states that sample composite material plaques were pressed and cured in about 2 1/2 to 3 minutes, and that this is a remarkably fast manufacturing time as compared to slow curing resin molding which can require 8-24 hours to cure and an additional 2-6 hours to post-cure. The CM application also states that the ability to quickly manufacture products with the composite material disclosed therein provides significant advantages, such as high-speed manufacturing, continuous sheet production lines, and reduced manufacturing costs.

The CM application also teaches a sheeting process to make composite material boards. The CM application states that this process comprises a number of steps including, among others, the use of a pan, similar to a cooking sheet, for holding the components used to make the board, or other mold form having a desired shape. For example, the CM application states that woven fabric such as carbon fiber can be placed in the pan, a composite material can be placed on top of the carbon fiber, and that a second sheet of carbon fiber can be placed on top of the composite material.

The composite material disclosed in the CM application exhibits remarkable properties, and is suitable for use in a myriad of applications as discussed in the CM application. However, the manufacturing processes disclosed in the CM application are not operative to produce large numbers of articles in a continuous manufacturing process.

### BRIEF SUMMARY OF THE INVENTION

It is desirable to provide a method of manufacturing articles utilizing a composite material having a high density of small particles such as microspheres in a matrix material that is capable of commercial scale applications. One aspect of the present invention is that at least two layers of flanking material are pull-truded through a die while a composite material is injected into a space defined between the at least two layers of flanking material. A second aspect of the invention is that the at least two layers of flanking material are disposed in a generally non-parallel relationship with respect to each other. The composite material and the at least two flanking material layers are heated as they are pull-truded through the die to cure the composite material and bond the flanking material layers to the composite material. The cured article may be formed into a desired shape.

Providing such a method has a number of distinct advantages. First, the manufacturing process disclosed herein is suitable for a myriad of commercial scale applications in which large numbers of composite material articles may be formed. Second, use of the manufacturing process disclosed herein significantly reduces the material and labor costs associated with manufacturing composite material articles. Third, the manufacturing process disclosed herein is an in-line process that significantly reduces the number of steps required to manufacture commercially viable composite material articles.

Other features and advantages of the invention will become apparent from the description that follows.

### BRIEF DESCRIPTION OF THE DRAWINGS

The objects and advantages of the present invention will become more readily apparent to those of ordinary skill in the relevant art after reviewing the following detailed description and accompanying drawings, wherein:

FIG. 1 is general, schematic diagram of a first embodiment of an apparatus for manufacturing articles utilizing a composite material having a high density of small particles, such as microspheres, in a matrix material;

FIG. 2 is a side view of a pulltrusion die and the input of the pulltrusion die shown in FIG. 1;

FIG. 3 is a side, perspective view of a roll of exemplary flanking material that is utilized in the apparatus shown in FIG. 1;

FIG. 4 is a side, sectional view of the core material injector shown in FIG. 1;

FIG. 5A is an exploded view of an exemplary article that is manufactured using the apparatus shown in FIG. 1;

FIG. 5B is an end view of the article shown in FIG. 5A;

FIG. 6 is a general, schematic diagram of a second embodiment of an apparatus for manufacturing articles using a composite material having a high density of small particles, such as microspheres, in a matrix material, wherein at least two layers of flanking material that are disposed in a generally non-parallel relationship to each other are utilized;

FIG. 7 is a side view of a pulltrusion die and the input of the pulltrusion die shown in FIG. 6;

FIG. 8 is a bottom, perspective view of a first embodiment of the core material injector shown in FIG. 6;

FIG. 9 is a front, perspective view of a second embodiment of the core material injector shown in FIG. 6;

FIG. 10 is a is a side, perspective view of the core material injector shown in FIG. 9; and

FIG. 11 is an exploded view of an exemplary article that is manufactured using the apparatus shown in FIG. 6.

### DETAILED DESCRIPTION OF THE INVENTION

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description Of The Invention”) relates to a requirement of the United States Patent Office, and should not be found to be limiting to the subject matter disclosed and claimed herein.

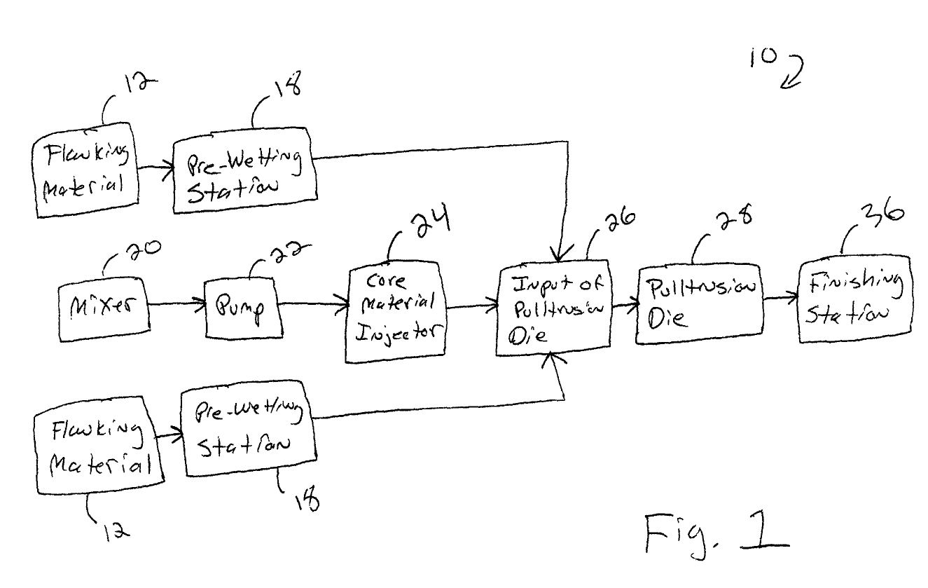

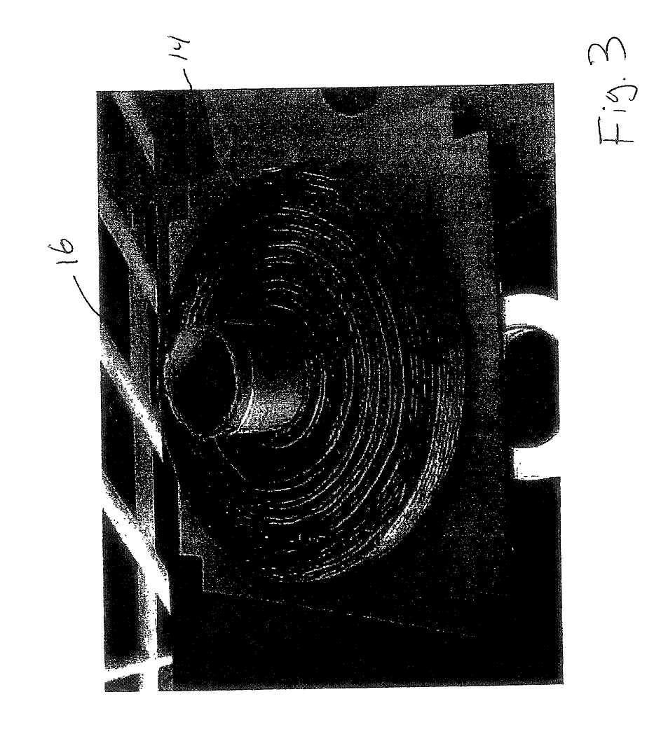

Referring to FIG. 1, a general, schematic diagram of an apparatus 10 for manufacturing articles utilizing a composite material having a high density of small particles, such as microspheres, in a matrix material is shown. Apparatus 10 includes two sources of flanking material 12 that, in an exemplary embodiment of the invention, comprise uni-directional stitch woven carbon fiber 14 that is rolled on a support member 16 as shown in FIG. 3. It should be understood that other materials are suitable for use as flanking materials such as, for example, glass fibers, uni-directional fibers, cross-woven fibers, matte fibers, fiber braid, carbon felt, plastics, leather, foil, metal, composites, thermoplastics, thermoset materials, resins, ceramics, vinyls and the like.

Apparatus 10 includes an optional feature of two pre-wetting stations 18 through which the flanking materials 12 are fed. When utilized, pre-wetting stations 18 apply an appropriate layer of resin on a surface of the flanking material 12 to aid in the application of composite material to the flanking material 12. It should be understood, however, that the pre-wetting stations 18 are optional features and are not required to make an article that is manufactured from the composite material disclosed in the CM application.

A mixer 20 and a pump 22 form a portion of apparatus 10. Mixer 20 contains a supply of composite material such as, for example, the various composite materials disclosed in the CM application. The particular composite material that is used depends upon the type of article that is to be manufactured as, for example, discussed in the CM application. Pump 22 provides the particular composite material that is used to a core material injector 24 that is utilized to introduce the composite material between the flanking material layers 12 at the input 26 of the pulltrusion die 28 as discussed in greater detail hereafter.

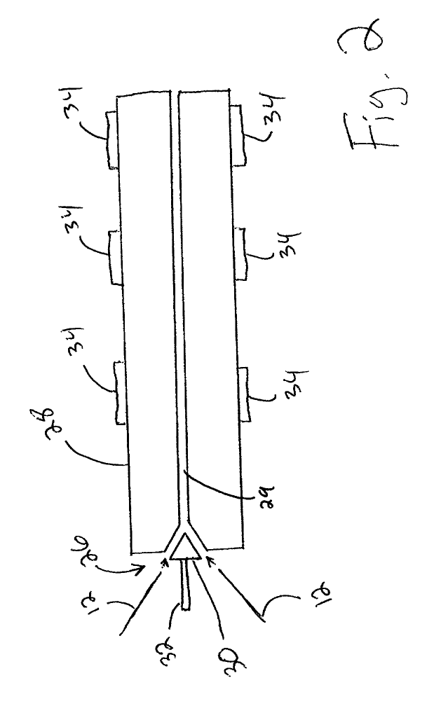

Referring to FIG. 2, a side view of an embodiment of the pulltrusion die input region 26 and the pulltrusion die 28 is shown. In the illustrated embodiment, two layers of flanking material 12 are fed into the pulltrusion die input region 26 by means of a wedge member 30. Wedge member 30 includes a pipe 32 that is connected to pump 22 (FIG. 1) and through which the composite material from mixer 20 flows. Wedge member is utilized to introduce an appropriate amount of composite material between adjacent surfaces of the two flanking material layers 12 in a continuous in-line process.

Pulltrusion die 28 pulls the flanking material layers 12 through an operating chamber 29. Pulltrusion die 28 also includes a plurality of heaters 34 that are schematically shown in FIG. 2. Heaters 34 are used to apply an appropriate amount of heat into the operating chamber 29 to cure the composite material and, therefore, bond it to the flanking material layers 12 as they pass through pulltrusion die 28. The cured article is passed to the finishing station 36 (FIG. 1) for further processing, if desired.

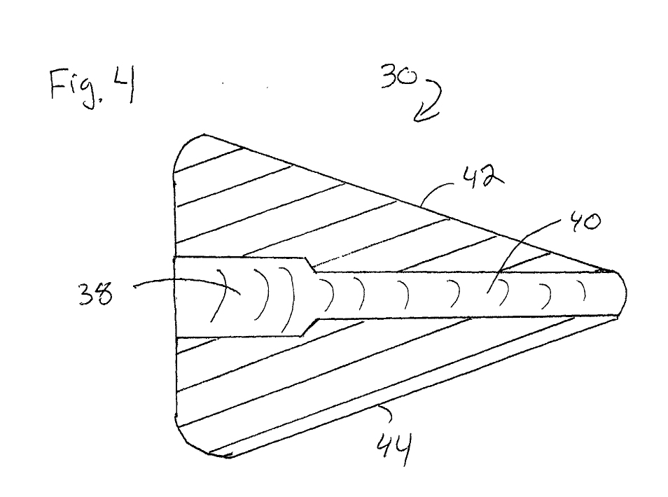

Referring to FIG. 4, a side, sectional view of the wedge member 30 is disclosed. In the illustrated embodiment, wedge member 30 includes a central input portion 38 that receives an end portion of pipe 32. Pipe 32 and central input portion 38 are joined together by, for example, the provision of corresponding threads on portion 38 and pipe 32. However, other methods of attachment may be utilized as readily apparent to those of ordinary skill in the art. A longitudinal channel 40 communicates with central input portion 38 to allow core material to be injected between the two layers of flanking material 12 shown in FIG. 2.

Wedge member 30 includes two inclined surfaces 42 and 44. In the illustrated embodiment, at least a portion of the flanking material 12 contacts the inclined surfaces 42 and 44 of wedge member 30. This allows, for example, the flanking material 12 to be guided into the pulltrusion die 28.

Stiffener bars for use in pallet applications are an example of an article that may be manufactured in accordance with the manufacturing process disclosed in this application. Existing pallets have been manufactured using plastics. However, plastic pallets have included additional reinforcement materials for heavy-duty applications. One existing plastic pallet includes five square steel tubes of a predetermined size as reinforcement inserts to meet government & grocery market specifications. Each pallet requires five tubes that cumulatively weigh about 27 pounds. One industry requirement is that the reinforcement bars must not exceed a certain deflection at the midpoint when a certain uniform weight load is distributed on a plastic pallet of a certain size.

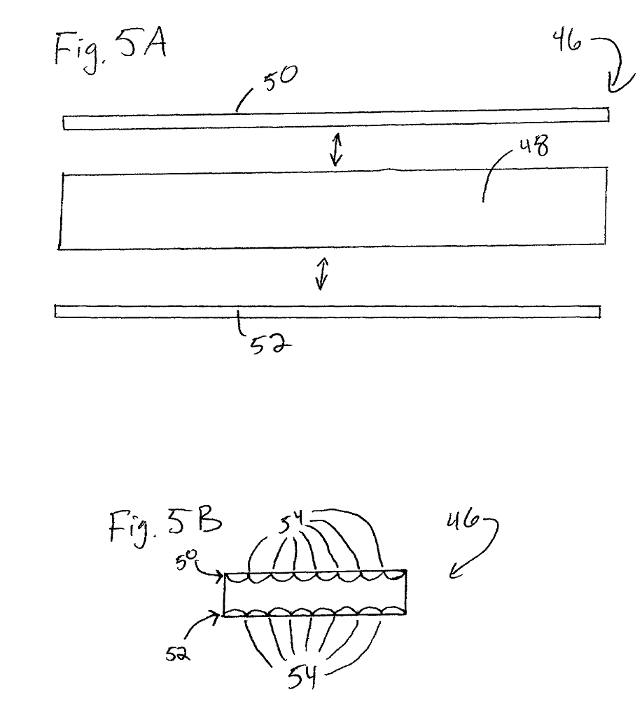

An exploded view of a bar 46 that is made of the composite material disclosed in the CM application and that satisfies the deflection requirement mentioned above is shown in FIG. 5A. In this embodiment of the invention, the bar 46 includes a composite material core 48 having 48% by weight microspheres and 52% by weight resin and flanked with two layers 50 and 52 of linear flanking material. The new composite material bar 46 performed to the required stiffness with an overall weight reduction of about 25 pounds over steel (a 92% reduction). It should be understood that composite materials other than those discussed above are suitable for use in this application of the present invention.

FIG. 5B shows an end view of the composite material bar 46 shown in FIG. 5A. In the illustrated embodiment of the invention, both flanking material layers 50 and 52 include a plurality of stitching lines 54 that divide the carbon fibers of the flanking layers 50 and 52 into a number of groups as shown. Another significant advantage of the present invention is that, for example, passing the flanking material layers 50 and 52 under tension from the pulltrusion die 26 and over at least a portion of the inclined surfaces 40 and 42 of the wedge member 30 generally enhances the perpendicular orientation of the individual carbon fibers with respect to the outside edges of each flanking material layer. This causes, for example, the stiffener bar to be stronger and generally less susceptible to breaking.

One significant advantage of the inventive manufacturing process disclosed herein is that it is especially suited for commercial applications, and that it allows large numbers of composite material articles to be manufactured in a cost efficient and effective manner. For example, in the case that pallet stiffener bars are to be manufactured, finishing station 36 cuts the cured article exiting from the pulltrusion die 26 to the desired size for the particular pallet stiffener bar application desired.

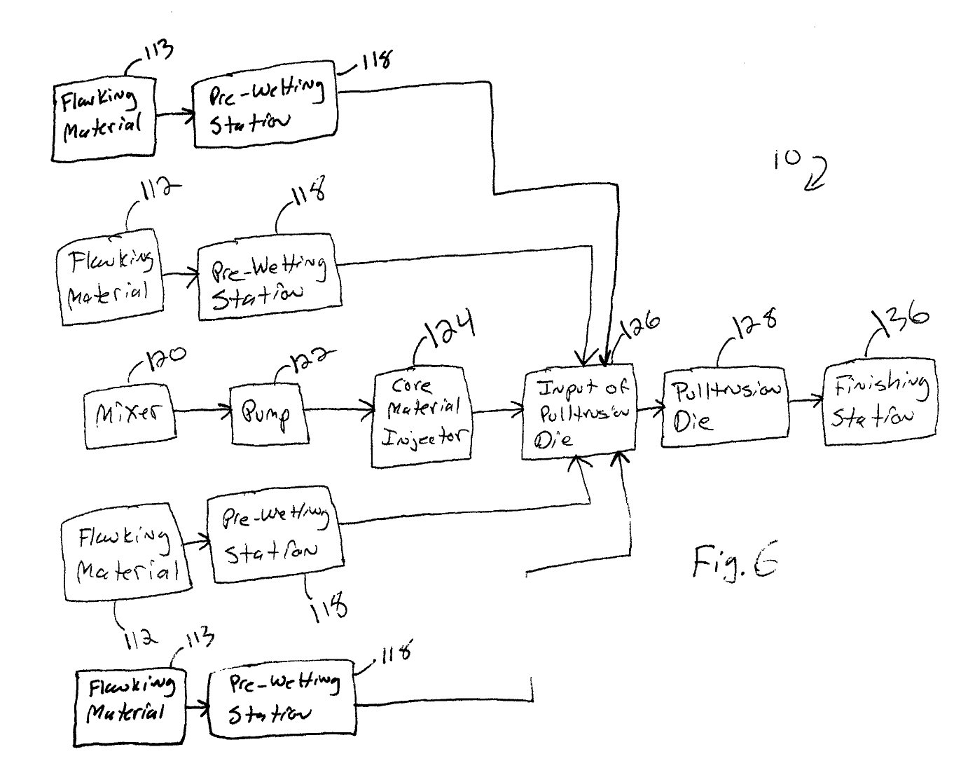

Referring to FIG. 6, a general, schematic diagram of an apparatus 110 for manufacturing articles utilizing a composite material having a high density of small particles, such as microspheres, in a matrix material is shown. Apparatus 110 includes two sources of flanking material 112 and two sources of flanking material 113 (i.e., four total sources of flanking material). Flanking material sources may comprise, in an exemplary embodiment of the invention, uni-directional stitch woven carbon fiber provided on a storage or support member as shown in FIG. 3, or any other suitable material such as, for example, glass fibers, uni-directional fibers, cross-woven fibers, matte fibers, fiber braid, carbon felt, plastics, leather, foil, metal, composites, thermoplastics, thermoset materials, resins, ceramics, vinyls, fiberglass, and the like.

Apparatus 110 includes an optional feature of four pre-wetting stations 118 through which the flanking materials 112 and 113 are fed. When utilized, pre-wetting stations 118 apply an appropriate layer of resin on a surface of the flanking materials 112 and 113 to aid in the application of composite material to the flanking materials 112 and 113. It should be understood, however, that the pre-wetting stations 118 are optional features and are not required to make an article that is manufactured from the composite material disclosed in the CM application.

A mixer 120 and a pump 122 form a portion of apparatus 110. Mixer 120 contains a supply of composite material such as, for example, the various composite materials disclosed in the CM application. The particular composite material that is used depends upon the type of article that is to be manufactured as, for example, discussed in the CM application. Pump 122 provides the particular composite material that is used to a core material injector 124 that is utilized to introduce the composite material between the flanking material layers 112 and 113 at the input 126 of the pulltrusion die 128 as discussed in greater detail hereafter.

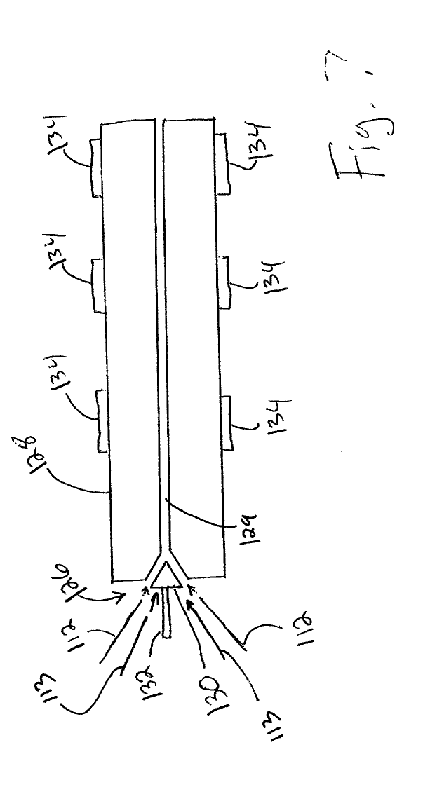

Referring to FIG. 7, a side view of the pulltrusion die input region 126 and the pulltrusion die 128 is shown. In the illustrated embodiment, two layers of flanking material 112 and two layers of flanking material 113 are fed into the pulltrusion die input region 126 by means of a wedge member 130. Wedge member 130 includes a pipe 132 that is connected to pump 122 (FIG. 6) and through which the composite material from mixer 120 flows. Wedge member is utilized to introduce an appropriate amount of composite material between the space defined between two flanking material layers 112 and the flanking material layers 113 in a continuous in-line process.

Pulltrusion die 128 pulls the flanking material layers 112 and 113 through an operating chamber 129. Pulltrusion die 128 also includes a plurality of heaters 134 that are schematically shown in FIG. 7. Heaters 134 are used to apply an appropriate amount of heat into the operating chamber 129 to cure the composite material and, therefore, bond it to the flanking material layers 112 and 113 as they pass through pulltrusion die 128. The cured article is passed to the finishing station 136 (FIG. 6) for further processing, if desired.

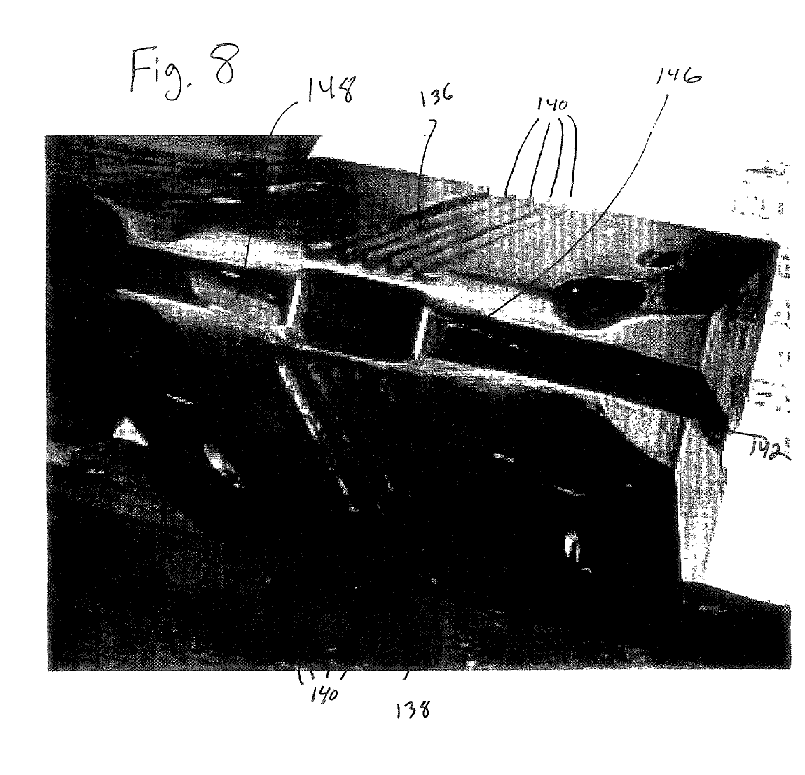

FIG. 8 is a bottom, perspective view of a first embodiment of the core material injector shown in FIG. 6. In particular, wedge member 130 includes two inclined surfaces 136 and 138 that are defined on the top and bottom of wedge member 30 as shown. Two layers of flanking material 112 are guided into the operating chamber 129 of the pulltrusion die 128 in a like manner to, and as discussed above with regard to the embodiment shown in FIG. 4. An optional feature of the present invention is that a number of raised ridges or combs 140 are defined on each of the inclined surfaces 136 and 138. One advantage provided by the combs 140 is that the combs 140 generally increase axial alignment of any fibers that are present in the flanking material layers 112 as they pass over at least a portion of the inclined surfaces 136 and 138. It should be understood that combs 140 are an optional feature that is not required by the present invention, and that it is contemplated that the combs 140 are utilizable in connection with the embodiment of the invention shown in FIG. 4, as well as the embodiments of the invention that are discussed in greater detail hereinafter.

Wedge member 130 includes two channels 142 and 144 that are formed in the two sides or ends of the wedge member 130. Each channel 142 and 144 includes a corresponding inclined surface 146 and 148. One aspect of the present invention is that the flanking material layers 113 are guided into the operating chamber 129 of the pulltrusion die 128 at least in part by the passage of the flanking material layers 113 through the channels 142 and 144. The flanking material layers 113 also are guided into the operating chamber 129 by at least some contact with inclined surfaces 146 and 148.

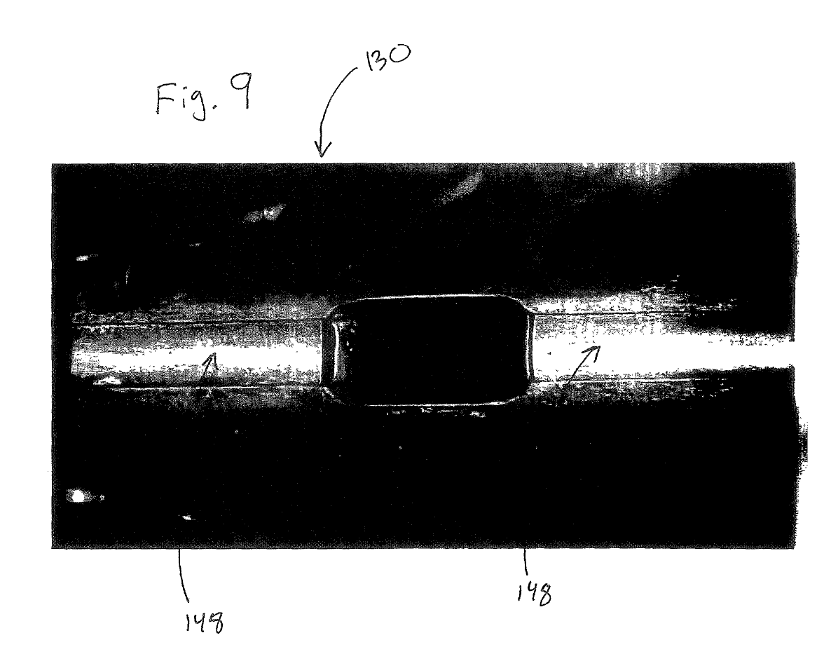

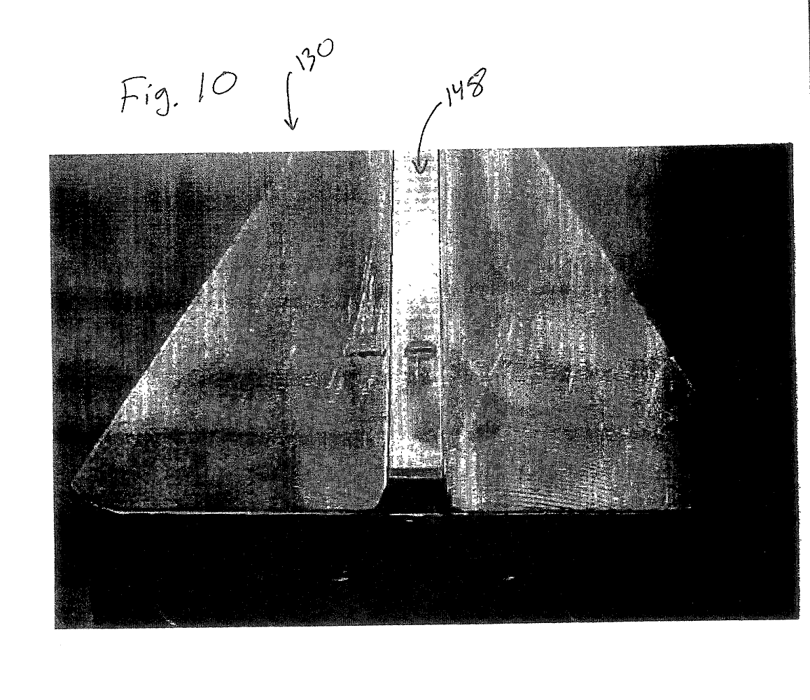

FIG. 9 is a front, perspective view of a second embodiment of the core material injector 124 shown in FIG. 6. FIG. 10 is a is a side, perspective view of the core material injector 124 shown in FIG. 9. FIGS. 9 and 10 illustrate that a guiding mechanism 148 is inserted into the channels 142 and 144. One aspect of the present invention is that guiding mechanism 148 serves to ensure that the flanking material layers 113 are guided into the operating chamber 129 of the pulltrusion die 128 in a desired relationship with respect to the flanking material layers 112. In the illustrated embodiment of the invention, the guiding mechanism comprises an angled member that is mounted in the channels 142 and 144. It should be understood, however, that the utilization of the guiding mechanism 148 is an optional feature of the present invention.

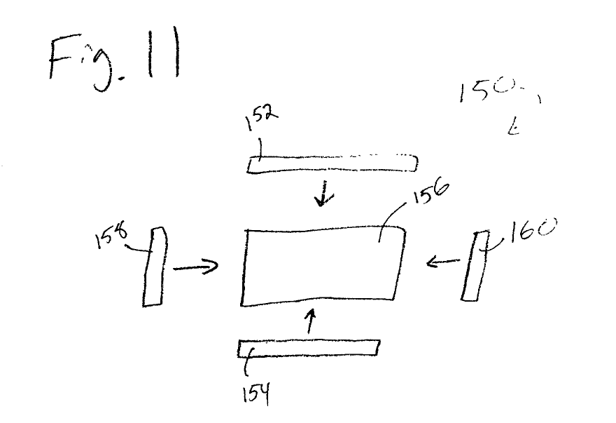

FIG. 11 is an exploded view of an exemplary article 150 that is manufactured using the apparatus shown in FIG. 6. Article 150 includes two layers of flanking material 152 and 154 that are affixed to the top and bottom, respectively, of a central core 156 that is formed from a composite material as discussed above with regard to FIGS. 5A and 5B. Two flanking material layers 158 and 160 are secured to the side or ends of the central core 156 as shown in FIG. 11. Materials suitable for use as flanking material layers 152, 154, 158, and 160 are discussed above with regard to the embodiments of the invention illustrated in FIGS. 1-6. For example, in an exemplary application of the present invention, flanking material layers 152 and 154 are formed from uni-directional stitch woven carbon fiber, whereas flanking material layers 158 and 160 are formed from fiberglass rolls. It should be understood that the utilization of combs 140 on wedge member 130 provides significant advantages when used in connection with fiber materials such as unidirectional stitch woven carbon fiber because, for example, the strength and integrity of the resulting article is increased due to the enhanced relationship of the fibers that is caused by contact with at least a portion of the combs 140.

From the foregoing it will be observed that numerous modifications and variations can be effectuated without departing from the true spirit and scope of the novel concepts of the present invention. It is to be understood that no limitation with respect to the specific embodiments illustrated is intended or should be inferred.

The disclosure is intended to cover by the appended claims all such modifications as fall within the scope of the claims when the claims are properly interpreted.

What is claimed is:

1. A method of manufacturing an article using a composite material that has a high density of small particles such as microspheres disposed in a matrix material, said method comprising the steps of:
providing a source of said composite material;
providing at least first and second layers of flanking material;
pulltruding said at least first and second layers of flanking material through a die, said first and second layers of flanking material being disposed in a generally non-parallel relationship with respect to each other;
injecting said composite material into a space defined between said at least first and second layers of flanking material; and
heating said injected composite material and said at least first and second layers of flanking material as they pass through said die to cure said composite material and to form a cured article.

2. The method of claim 1 wherein said flanking material is chosen from a group consisting of: carbon fibers, glass fibers, uni-directional fibers, cross-woven fibers, matte fibers, fiber braid, uni-directional stitch woven carbon fiber braid, carbon felt, felt, plastic, leather, foil, metal, composite, thermoplastic, thermoset, resin, fiberglass, and ceramic.

3. The method of claim 1 further comprising the step of providing a third layer of flanking material, wherein said pulling step comprises the step of pulling said first, second, and third layers of flanking material through said die, and wherein said injecting step comprises injecting said composite material into a space defined between adjacent surfaces of said first, second, and third flanking material layers.

4. The method of claim 3 wherein said first and third layers of flanking material are disposed in a generally parallel relationship with respect to each other.

5. The method of claim 3 wherein a wedge is used to inject said composite material into a space defined between said first, second, and third layers of flanking material, said wedge having a first and second inclined surfaces, said first and second layers of flanking material being guided into said die at least in part by contact with at least a portion of said first and second inclined surfaces.

6. The method of claim 1 wherein a wedge is used to inject said composite material into a space defined between said at least first and second layers of flanking material as they are being pulled through said die, said at least first and second layers of flanking material being guided into said die at least in part by contact with at least a portion of wedge.

7. The method of claim 6 wherein at least one comb is disposed on at least a portion of said wedge, an alignment of any fibers in said first layer of flanking material being generally increased by contact with said at least one comb.

8. The method of claim 1 wherein at least a portion of said cured article is generally planar.

9. The method of claim 8 wherein said cured article is generally planar.

10. The method of claim 1 further comprising the step of forming said cured article into a desired shape.

11. The method of claim 10 wherein said forming step comprises machining at least a portion of said cured article.

12. The method of claim 10 wherein said forming step comprises cutting said cured article to a desired length.

13. An article, comprising:
at least first and second layers of flanking material that are disposed in a generally non-parallel relationship with respect to each other; and
a layer of composite material that has a high density of small particles such as microspheres disposed in a matrix material and that is bonded to a surface of said at least first and second layers of flanking material, said composite material being bonded to said at least one first and second layers of flanking material by pulltruding said at least first and second layers of flanking material through a die, injecting said composite material into a space defined between said at least first and second layers of flanking material as they pass through said die, heating said injected composite material and said at least first and second layers of flanking material as they pass through said die to form a cured article, and forming said cured article into a desired shape.

14. The article of claim 13 wherein said flanking material is chosen from a group consisting of: carbon fibers, glass fibers, uni-directional fibers, cross-woven fibers, matte fibers, fiber braid, uni-directional stitch woven carbon fiber braid, carbon felt, felt, plastic, leather, foil, metal, composite, thermoplastic, thermoset, resin, fiberglass, and ceramic.

15. The article of claim 13 wherein at least a portion of said cured article is generally planar.

16. The article of claim 15 wherein said cured article is generally planar.

17. A method of manufacturing an article using a composite material that has a high density of small particles such as microspheres disposed in a matrix material, said method comprising the steps of:
providing a source of said composite material;
providing at least one layer of flanking material;
pulltruding said at least one layer of flanking material through a die;
injecting said composite material onto a surface of said at least one layer of flanking material;
heating said injected composite material and said at least one flanking material as it passes through said die to cure said composite material and form a cured article;
wherein a wedge is used to inject said composite material onto said surface of said at least one layer of flanking material as it is being pulled through said die, said first layer of flanking material being guided into said die at least in part by contact with at least a portion of said wedge; and
wherein at least one comb is disposed on at least a portion of said wedge, an alignment of any fibers in said at least one layer of flanking material being generally increased by contact with said at least one comb.
